(19) United States
(12) Patent Application Publication
(10) Pub. No.: US 2009/0300251 A1
(43) Pub. Date: Dec. 3, 2009

(54) COMPUTER EQUIPMENT

(75) Inventor: Kuo-Huang Lu, Jung-He City (TW)

Correspondence Address: APEX JURIS, PLLC, 12733 LAKE CITY WAY NORTHEAST, SEATTLE, WA, 98125, US

(73) Assignee: MICRO-STAR INTERNATIONAL CO., LTD., Jung-He City (TW)

(21) Appl. No.: 12/177,365

(22) Filed: Jul. 22, 2008

(30) Foreign Application Priority Data
May 28, 2008 (TW) 097119772

(51) Int. Cl. G06F 13/00

(52) U.S. Cl. 710/300

(57) ABSTRACT

A computer equipment includes a primary body and a secondary body. The primary body includes a primary host for performing computer operations independently and a primary monitor for displaying the computer operations. The secondary body includes a secondary host for performing computer operations independently and a touch monitor for displaying the computer operations. The secondary host is combined with the primary host, and is electrically connected to the primary host. A user can use the primary body as an expansion dock of the secondary body, such that the primary monitor is switched to display an operation status of the secondary host. Or, the user can use the secondary body as an input device of the primary body, such that the touch monitor is switched to control operation of the primary host, and the primary monitor displays an operation status of the primary host.

### CROSS-REFERENCE TO RELATED APPLICATIONS

This non-provisional application claims priority under 35 U.S.C. § 119(a) on Patent Application No(s). 097119772 filed in Taiwan, R.O.C. on May 28, 2008 the entire contents of which are hereby incorporated by reference.

### BACKGROUND OF THE INVENTION

1. Field of Invention

The present invention relates to a computer equipment, and more particularly to a computer equipment having two separate standard main bodies.

2. Related Art

With the development of the information industry, computer products make life become more convenient. Therefore, modern people rely much on the computer products in terms of the life and work. In recent years, due to the requirements of the users for portability and mobile business, notebook computers have replaced earlier desktop computers and become the mainframe computer products in the market. Since the notebook computers are small, light, and easy to carry, the users are not restricted to work at specific sites. Thus, the notebook computers are more convenient to use in daily life.

In the trend of pursuing light and thin computers in the market, the volume of the notebook computers becomes smaller and thinner. Thus, the notebook computers may not have sufficient space for accommodating connection ports for communications that should be configured originally, so the connection capability with peripherals and the hardware expansion capability of the notebook computers are limited. Therefore, currently, some manufacturers provide special expansion docks for the notebook computers. The expansion docks can be used in combination with the notebook computers directly, and have some standard connection ports for communication. In addition, the expansion docks can further connect peripherals such as optical drives or hard drives, so as to enhance the connection capability with peripherals and the hardware expansion capability of the notebook computers. The development of the expansion docks is quite mature, and many patents have disclosed the expansion docks, for example, U.S. Pat. Nos. 7,359,185, 7,298,613, 7,038,908, and 6,135,801.

However, in the above patents, the expansion docks are only media for transmitting data and power, and are not equipped with monitors. As the volume of a notebook computer is small, the size of the screen of the notebook computer is also small. When the notebook computer is placed on a desk, the notebook computer does not conform to the ergonomic principles. After a long term use of the notebook computer, the user may have to take a wrong posture to view the screen, or the eyesight of the user may be impaired. Therefore, many users will buy another monitor to be used with the expansion dock. However, the additional monitor costs more money, and the connection wires between the monitor and the expansion dock occupy much space on the desk or make the space disordered. Accordingly, designs that integrate a large-size LCD display and an expansion dock are developed to solve the previous problems. For example, US Patent No. 2005/0270731 and 2008/002350 disclose an expansion dock integrating a monitor.

In the above patents related to the expansion dock having the monitor, a notebook computer can be easily assembled on the expansion dock, such that the monitor of the expansion dock displays the operation status of the notebook computer. However, the expansion dock having the monitor is a media for transmitting data and power only, and is provided with the function of displaying the screen images of the notebook computer, so the expansion dock cannot work independently before being combined with the notebook. Therefore, the expansion dock having the monitor has limited functions, and is expensive but not practical due to the high cost. This design is not favorable by customers.

### SUMMARY OF THE INVENTION

To solve the problems that the expansion docks of notebook computers are expensive and not practical in the prior art, the present invention is directed to a computer equipment for solving the problem of limited functions of the conventional expansion docks.

Accordingly, the present invention provides a computer equipment, which includes a primary body and a secondary body. The primary body has a primary host and a primary monitor pivoted to the primary host, and the primary body is substantially an expansion dock computer having a monitor. The primary host has the hardware architecture of a common computer system, and can perform computer operations independently. The primary monitor is electrically connected to the primary host, and displays an operation status of the primary host when the primary host performs the computer operations independently. The primary host further has an expansion slot and a primary connector disposed in the expansion slot. The secondary body has a secondary host and a touch monitor, and the secondary body is substantially a portable computer. The secondary host also has the hardware architecture of a common computer system, and can perform computer operations independently. The secondary host has a secondary connector that matches and can be connected by insertion with the primary connector of the primary host. The touch monitor is electrically connected to the secondary host, for displaying an operation status of the secondary host when the secondary host performs the computer operations independently. The touch monitor is triggered by a user in a first mode to control operations of the secondary host. When the secondary host is assembled to the expansion slot of the primary host, the secondary connector of the secondary host is connected by insertion to the primary connector of the primary host, so as to electrically connect the primary host and the secondary host. Meanwhile, the user can select operation modes after the primary host and the secondary host are combined. In a first operation mode, the primary monitor is switched to display the computer operation status of the secondary host, such that the touch monitor maintains the first mode to control the operations of the secondary host. In a second operation mode, the touch monitor is switched to a second mode, and is triggered to control the operations of the primary host, and the primary monitor is made to display the operation status of the primary host.

The present invention has the following effect. When the secondary host is separate from the primary host, the two parts can perform the computer operations independently, and when the secondary host is combined with the primary host, they perform the computer operations together. When the secondary host is combined with the primary host, the primary monitor can be switched to display the computer operation status of the secondary main computer or to display the computer operation status of the primary host, and the touch monitor can be switched to control the computer operation status of the secondary host or to control the computer operation status of the primary host. Thus, the functions of the primary host (the expansion dock computer) and the secondary host (the portable computer) are effectively enhanced to meet the users' requirements on practicality.

### BRIEF DESCRIPTION OF THE DRAWINGS

The present invention will become more fully understood from the detailed description given herein below for illustration only, and thus are not limitative of the present invention, and wherein:

FIG. 1 is a schematic view of a computer equipment of the present invention when the primary body is separate from the secondary body;

FIG. 2 is a schematic view of a computer equipment of the present invention when the primary body is combined with the secondary body;

FIG. 3 is a schematic view of a computer equipment of the present invention when the primary body is combined with the secondary body and the primary monitor is closed; and

FIG. 4 is a block diagram of functions of the computer equipment of the present invention.

### DETAILED DESCRIPTION OF THE INVENTION

To make the objectives, structures, features, and functions of the present invention more comprehensible, the present invention is illustrated in detail with reference to the embodiments below.

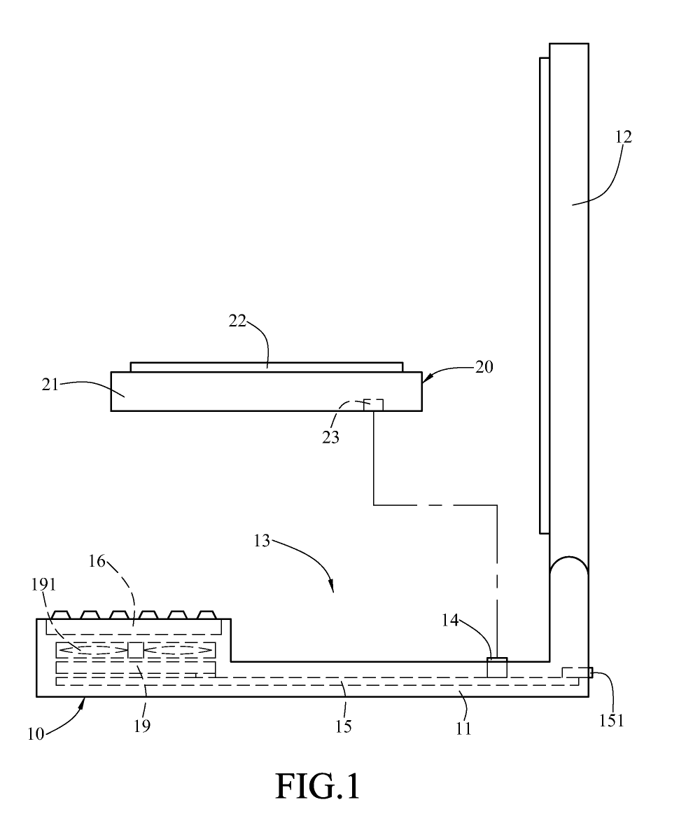

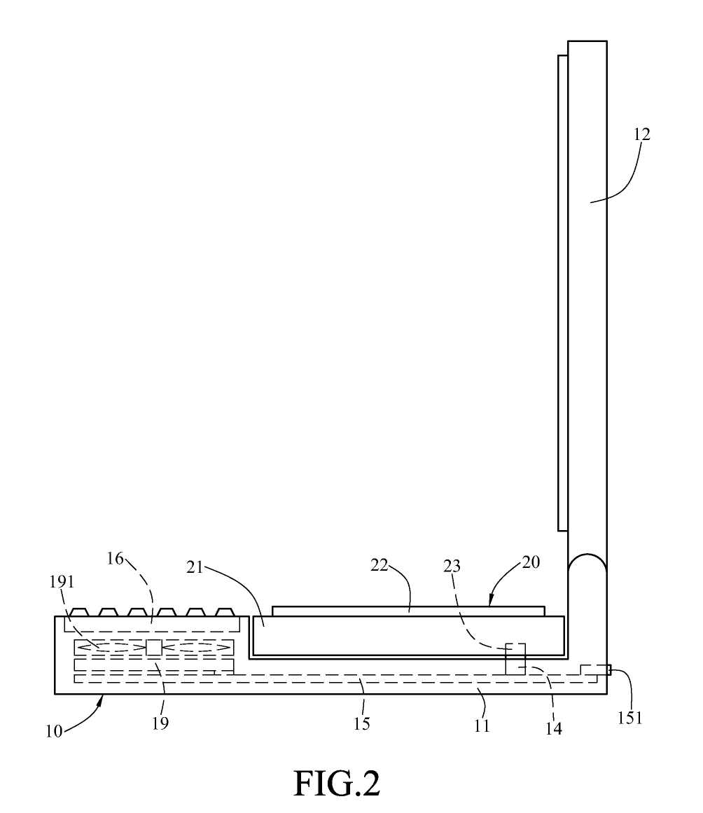

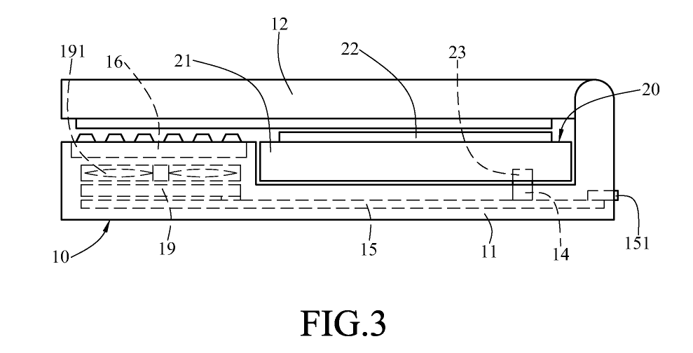

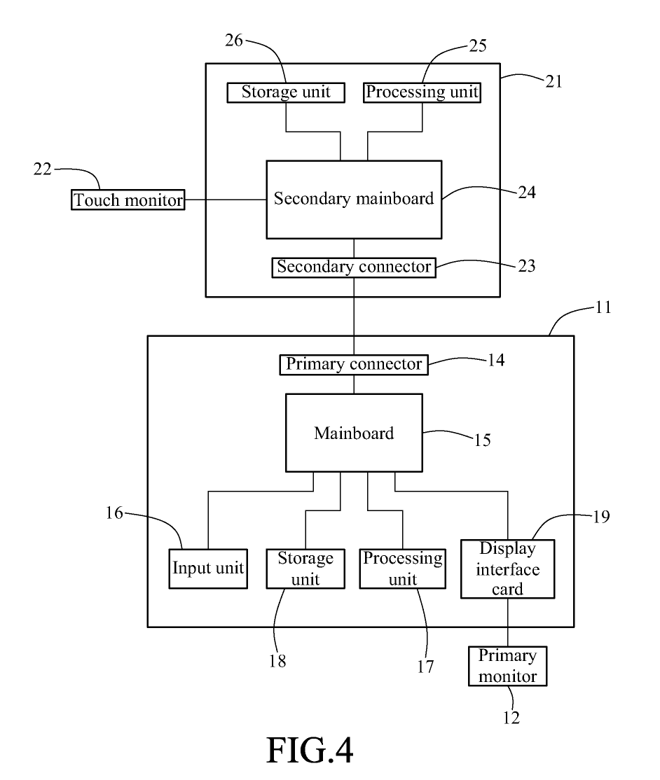

FIGS. 1-4 show a computer equipment of the present invention. The computer equipment includes a primary body 10 and a secondary body 20. The primary body 10 and the secondary body 20 can operate independently. The secondary body 20 can be combined with the primary body 10, and can be used in a plurality of operation modes after being integrated with the primary body 10.

Referring to FIGS. 1, 2, 3, and 4, the primary body 10 has a primary host 11 and a primary monitor 12. The primary body 10 is substantially an expansion dock computer having a large-size monitor, which can be used as the common computer or an expansion dock of the secondary body 20. The primary host 11 has the hardware architecture of a common main body, including a mainboard, a CPU, a cache memory, a hard drive, an optical drive, and a power supply. Specific operating software can be installed on the primary host 11, such that the primary host 11 of the primary body 10 can perform computer operations independently. The primary monitor 12 is pivoted to one side of a case of the primary host 11, and is electrically connected to the primary host 11. The primary monitor 12 is substantially an LCD screen, and can display the operation status of the primary host 11 when the primary host 11 performs the computer operations independently.

The primary host 11 further has an expansion slot 13, a primary connector 14, a mainboard 15, an input unit 16, a storage unit 18, a display interface card 19, and a heat dissipation fan 191. The size of the expansion slot 13 matches with the size of the secondary body 20, so as to accommodate the secondary body 20. The primary connector 14 is disposed in the expansion slot 13, and the primary connector 14 is electrically disposed on the mainboard 15 or electrically connected to the mainboard 15. A processing unit 17 is electrically disposed on the mainboard 15. The processing unit 17 is substantially a central processing unit (CPU) of a main body. Furthermore, the processing unit 17 is electrically connected to the primary monitor 12, the primary connector 14, and the input unit 16 through the mainboard 15.

A plurality of communication ports 151 is electrically disposed on the mainboard 15. For example, the communication ports 151 may be printer ports, universal bus port, and audio and visual interface ports. The input unit 16 is electrically connected to the mainboard 15, and the input unit 16 is triggered to control the operations of the primary host 11. The input unit 16 is substantially a computer keyboard integrated in the primary host 11. The storage unit 18 is electrically plugged on the mainboard 15, or is electrically connected to the mainboard 15. The storage unit 18 is substantially a cache memory module or a hard drive of a main body, which stores software programs and data files to be processed by the processing unit 17. The display interface card 19 is electrically plugged on the mainboard 15, and is electrically connected to the main monitor 12. When the primary host 11 operates, the processing unit 17 processes the generated display signals, and the display signals are first delivered to chips on the display interface card 19 for processing, and then are transmitted to the primary monitor 12 for display.

Referring to FIGS. 1, 2, 3, and 4, the secondary host 20 has a secondary host 21 and a touch monitor 22. The secondary host 20 is substantially a portable computer, for example, a notebook computer, a tablet personal computer, or an ultra mobile personal computer (UMPC). The secondary host 21 also has the hardware architecture of a common main body, and can perform computer operations independently. The secondary host 21 has a secondary connector 23 that matches and can be connected by insertion with the primary connector 14 of the primary host 11. The touch monitor 22 is disposed on the secondary host 21, and is electrically connected to the secondary host 21. The touch monitor 22 is substantially an LCD touch screen. The touch monitor 22 displays the operation status of the secondary host 21 when the secondary host 21 performs computer operations independently, and is triggered by a user in a first mode to control the operations of the secondary host 21. Therefore, the touch monitor 22 may also be used as an input device of the secondary host 21, for example, a virtual keyboard or a virtual writing pad for the user to operate.

The secondary host 21 has a secondary mainboard 24, a processing unit 25, and a storage unit 26. The processing unit 25 is electrically disposed on the secondary mainboard 24, and is electrically connected to the touch monitor 22, the secondary connector 23, and the storage unit 26 through the secondary mainboard 24. The storage unit 26 is electrically plugged on the secondary mainboard 24, or is electrically connected to the secondary mainboard 24. The storage unit 26 is substantially a cache memory module or a hard drive of a main body, which stores software programs and data files to be processed by the processing unit 25. When the secondary host 21 operates, the processing unit 25 processes the generated display signals, and the generated display signals are delivered first to display chips on the secondary mainboard 24 for processing, and then are transmitted to the touch monitor 22 for display.

When the secondary host 21 of the secondary body 20 is assembled to the expansion slot 13 of the primary main board 11 of the primary body 10, the secondary connector 23 of the secondary host 21 is connected to the primary connector 14 of the primary host 11, so as to connect the primary host 11 and the secondary host 21. At this time, the secondary body 20 obtains power from the primary body 10, for example, the power supplier of the primary host 11 charges a rechargeable battery of the secondary host 21 through the primary connector 14 and the secondary connector 23. Meanwhile, the user can select a co-operation mode after the primary host 11 and the secondary host 21 are combined. For example, the user can select from a touch menu provided by the touch monitor 22, or can use the input unit 12 to select from a non-touch menu provided by the primary monitor 12. The above menus include a first operation mode and a second operation mode. The control programs applied by the menus are stored in the storage unit 18 and the storage unit 26, and are processed by the processing unit 17 and the processing unit 25.

When the secondary host 21 and the primary host 11 are combined and electrically connected, if the user selects the first operation mode, the primary monitor 12 is switched to display the computer operation status of the secondary host 21 by the processing unit 17, the touch monitor 22 of the secondary host 21 remains at the first mode to control the operations of the secondary host 21, and the input unit 16 is switched to control the operations of the secondary main machine 21 and to transmit the signals of the secondary host 21 to the communication ports 151. Therefore, the signals of the secondary host 21 are transmitted to external devices by the primary host 11, or the primary host 11 receives external signals, such that the secondary host 21 is connected to other computer peripherals, for example, a mouse, joystick, or printer connected to the communication ports 151 or an optical drive or hard drive installed on the primary host 11. After the user selects the operation mode, the touch monitor 22 still displays the operation status of the secondary host 21, or detects finger displacements of the user to control the movements of a cursor on the primary monitor 12. Therefore, when the user selects the first operation mode, the primary host 10 functions as an expansion dock of the secondary host 20.

After the secondary host 21 and the primary host 11 are combined and are electrically connected, if the user selects a second operation mode, the processing unit 17 switches the touch monitor 22 to a second mode, in which the touch monitor 22 is triggered to control the operations of the primary host 11, and the processing unit 17 controls the primary monitor 12 to keep displaying the operation status of the primary host 11, such that the input unit 16 keeps controlling the operations of the primary host 11, and transmits the signals of the primary host 11 to the communication ports 151. After the user selects the operation mode, the processing unit 17 controls the touch monitor 22 to provide a virtual touchpad, such that the touch monitor 22 detects the finger displacements of the user to control the movements of a cursor on the primary monitor 12. Therefore, when the user selects the second operation mode, the primary body 10 can function as a common computer, and the secondary body 20 can function as an input device of the primary body 10.

In the present invention, when the secondary host is separate from the primary host, the two parts can perform their computer operations independently; and when the secondary host is combined with the primary host, the two parts can be integrated to perform the computer operations. When the secondary host is combined with the primary man body, the primary monitor can be switched to display the computer operation status of the secondary host or the computer operation status of the primary host, and the touch monitor can be switched to control the computer operation status of the secondary host or the computer operation status of the primary host. Thus, the functions of the primary host (the expansion dock computer) and the secondary host (the portable computer) are effectively enhanced to meet the users' requirements on practicality.

What is claimed is:

1. A computer equipment, comprising:
a primary body, having a primary host and a primary monitor, wherein the primary host performs operations independently, the primary monitor displays an operation status of the primary host, and the primary host has an expansion slot and a primary connector disposed in the expansion slot; and
a secondary body, having a secondary host and a touch monitor, wherein the secondary host has a secondary connector and performs operations independently, such that the touch monitor displays an operation status of the secondary host and is triggered in a first mode to control the operations of the secondary host, or the secondary host is assembled in the expansion slot of the primary host, such that the secondary connector is connected by insertion to the primary connector, so as to electrically connect the primary host and the secondary host, and the primary monitor is switched to display the operation status of the secondary host or the touch monitor is switched to a second mode and is triggered to control the operations of the primary host, and the primary monitor displays the operation status of the primary host.

2. The computer equipment according to claim 1, wherein the primary host has an input unit, the input unit is triggered to control the operations of the primary host, or is switched to control the operations of the secondary host when the primary host and the secondary host are electrically connected.

3. The computer equipment according to claim 2, wherein the primary host has a mainboard, a processing unit is electrically disposed on the mainboard, and the processing unit is electrically connected to the primary monitor, the primary connector, and the input unit through the mainboard.

4. The computer equipment according to claim 3, wherein when the primary host and the secondary host are electrically connected, the processing unit controls the primary monitor to display the operation status of the primary host, or controls the primary monitor to switch to display the operation status of the touch monitor.

5. The computer equipment according to claim 3, wherein when the primary host and the secondary host are electrically connected, the processing unit makes the input unit to control the operations of the primary host, or switches the input unit to control the operations of the secondary host.

6. The computer equipment according to claim 3, wherein the primary host has a display interface card electrically plugged on the mainboard and electrically connected to the primary monitor.

7. The computer equipment according to claim 3, wherein a plurality of communication ports is electrically disposed on the mainboard, and when the primary host and the secondary host are electrically connected, the processing unit transmits signals of the primary host to the communication ports, or transmits signals of the secondary host to the communication ports.

8. The computer equipment according to claim 1, wherein the primary monitor is pivoted on the primary host.
